(19) United States
(12) Patent Application Publication
(10) Pub. No.: US 2016/0025344 A1
(43) Pub. Date: Jan. 28, 2016

(54) LOW POROSITY AUXETIC SHEET

(71) Applicants: PRESIDENT AND FELLOWS OF HARVARD COLLEGE, Cambridge, MA (US); ROLLS-ROYCE CANADA, LTD., Montreal (CA)

(72) Inventors: Katia BERTOLDI, Somerville, MA (US); Michael TAYLOR, Medford, MA (US); Ali SHANIAN, Montreal (CA); Miklos GERENDAS, Mellensee (DE); Carl CARSON, Beaconsfield (CA)

(21) Appl. No.: 14/776,507

(22) PCT Filed: Mar. 12, 2014
(86) PCT No.: PCT/US2014/024830

§ 371 Date: Sep. 14, 2015

Related U.S. Application Data
(60) Provisional application No. 61/791,050, filed on Mar. 15, 2013.

(51) Int. Cl. F23R 3/08; F23R 3/00

(52) U.S. Cl. CPC F23R 3/08; F23R 3/002; F05B 2220/302; F05B 2240/35

(57) ABSTRACT

A low porosity sheet material comprising an arrangement of elongated void structures, each of the elongated void structures including one or more substructures, a first plurality of first elongated void structures and a second plurality of second elongated void structures, each of the first and second elongated void structures having a major axis and a minor axis, the major axes of the first elongated void structures being perpendicular to the major axes of the second elongated void structures, the first and second pluralities of elongated void structures being arranged in an array of rows and columns, each of the rows and each of the columns alternating between the first and the second elongated void structures, wherein a porosity of the elongated void structures is below about 10%.

### TECHNICAL FIELD

The present disclosure relates generally to solids having engineered void structures.

### BACKGROUND

There are many examples of solids having engineered void structures, such engineered void structures provide a wide variety of mechanical, acoustic and thermal characteristics particular to the material and application.

U.S. Pat. No. 5,233,828 discloses an example of an engineered void structure for a gas turbine combustor liner. The operating temperature of the gas turbine combustor is near, and can exceed, 3,000° F. Consequently, the combustor liner is provided within the combustor to insulate the engine surroundings and prevent thermal damage to other components of the gas turbine. To minimize temperature and pressure differentials across the combustor liners, cooling slots have conventionally been provided, such as is shown in U.S. Pat. No. 5,233,828, in the form of spaced cooling holes disposed in a continuous pattern.

WO 2008/137201 discloses another example of an engineered void structure for a gas turbine combustor liner. In WO 2008/137201, the liner comprises a plurality of small, closely-spaced film cooling holes to provide a cooling film along a hot side of the liner (i.e., the side facing the hot combustion gases) from the cold side of the liner (i.e., the side in contact with the relatively cooler air in an adjacent passage). These cooling holes are disclosed to have a non-uniform diameter through the thickness of the liner, with the cold side holes having a first diameter that is smaller than the second diameter at the hot side, thus providing an aspect ratio other than 1.0 (e.g., a ratio of the second diameter to the first diameter may be 3.0 to 5.0).

U.S. Pat. No. 8,066,482 shows another example of a combustor liner having a particular engineered void structure, wherein the voids comprise elliptical shaped cooling holes having a first size at a cool side and a second, larger size at a hot size, thus presenting an aspect ratio greater than one. U.S. Pat. No. 8,066,482 further discloses that the elliptical shaped cooling holes are oriented parallel to the stress field so that the radius of curvature spreads the stress field and reduces stress concentrations.

EP 0971172 A1 likewise shows another example of a perforated liner used in a combustion zone of a gas turbine.

Currently, combustors liners such as those noted above are designed with a specific void structure or porosity, variously defined as the ratio of the area of holes relative to the area of the structure or as the ratio of the volume of holes relative to the volume of the structure, as applicable. Known elliptic voids have an aspect ratio of up to 50 in order to obtain the intended cooling behavior, but these known elliptic voids result in a very high stress at the tip.

FIG. 1(a) is a graph of Poisson's Ratio, ν, on the Y-axis against Strain on the X-axis, illustrating the negative Poisson's Ratio behavior of both experimental test results conducted on a rubber test specimen (denoted by circular data points) and numerical test results (Finite Element Modeling)(denoted by the solid line bounded between the upper and lower dashed lines). The vertical dashed line denotes the Nominal Strain, ε_{c}, the point at which critical true plastic strain is reached, which was −0.05 as indicated. Continuing levels of strain, as shown in the progression of FIGS. 1(b)-1(d) produced consistently lower and lower values for Poisson's ratio until finally it crossed zero and turned negative. In these studies, it was determined that if the porous test specimen was deformed strongly enough, a state of a negative Poisson's ratio (“NPR”) could be consistently exhibited. Thus, although rubber conventionally exhibits a positive Poisson's ratio, as most conventional materials, the particular arrangement of elliptical holes was determined to cause the positive Poisson's ratio to exhibit pseudo-auxetic properties.

### SUMMARY

Aspects of the present disclosure are directed to a solid, such as a solid sheet, having an engineered void structure that causes a solid having a positive Poisson ratio to exhibit pseudo-auxetic behavior upon application of stress to the solid. Accordingly, a material having a positive Poisson ratio can be structurally modified to microscopically behave as a material having a negative Poisson ratio (e.g., the material would expand laterally if subjected to a tensile force, or contract if subjected to a compressive force) in accord with the present concepts.

When materials are compressed along a particular axis they are most commonly observed to expand in directions orthogonal to the applied load. The property that characterizes this behavior is the Poisson's ratio, which is defined as the ratio between the negative transverse and longitudinal strains. The majority of materials are characterized by a positive Poisson's ratio, which is approximately 0.5 for rubber and 0.3 for glass and steel. Materials with a negative Poisson's ratio will contract (expand) in the transverse direction when compressed (stretched) and, although they can exist in principle, demonstration of practical examples is relatively recent. Discovery and development of materials with negative Poisson's ratio, also called auxetics, was first reported by Lakes in 1987. Investigations suggest that the auxetic behavior involves an interplay between the microstructure of the material and its deformation. Examples of this are provided by the discovery that metals with a cubic lattice, natural layered ceramics, ferro-electric polycrystalline ceramics, and zeolites may all exhibit negative Poisson's ratio behavior. Moreover, several geometries and mechanisms have been proposed to achieve negative values for the Poisson's ratio, including foams with reentrant structures, hierarchical laminates, polymeric and metallic foams

Negative Poisson's ratio effects have also been demonstrated at the micrometer scale using complex materials which were fabricated using soft lithography and at the nanoscale with sheets assemblies of carbon nanotubes. A significant challenge in the fabrication of materials with auxetic properties is that it usually involves embedding structures with intricate geometries within a host matrix. As such, the manufacturing process has been a functional limitation in the practical development towards applications. A structure which forms the basis of many auxetic materials is that of a cellular solid and research into the deformation these materials is a relatively mature field with primary emphasis on the role of buckling phenomena on load carrying capacity and energy absorption under compressive loading. Very recently, the results of a combined experimental and numerical investigation demonstrated that mechanical instabilities in 2D periodic porous structures can trigger dramatic transformations of the original geometry. Specifically, uniaxial loading of a square array of circular holes in an elastomeric matrix is found to lead to a pattern of alternating mutually orthogonal ellipses. This results from an elastic instability above a critical value of the applied strain. The geometric reorganization observed at the instability is both reversible and repeatable and it occurs over a narrow range of the applied load. Thus, this behavior provides opportunities for transformative materials with properties that can be reversibly switched. Moreover, it has been shown that the pattern transformation leads to unidirectional negative Poisson's ratio behavior for the 2D structure, i.e., it only occurs under compression. The uncomplicated manufacturing process of the samples together with the robustness of the observed phenomena suggests that this may form the basis of a practical method for constructing planar auxetic materials over a wide range of length-scales.

According to one aspect of the present disclosure, a low porosity sheet material comprising an arrangement of elongated void structures, each of the elongated void structures including one or more substructures, a first plurality of first elongated void structures and a second plurality of second elongated void structures, each of the first and second elongated void structures having a major axis and a minor axis, the major axes of the first elongated void structures being perpendicular to the major axes of the second elongated void structures, the first and second pluralities of elongated void structures being arranged in an array of rows and columns, each of the rows and each of the columns alternating between the first and the second elongated void structures, wherein a porosity of the elongated void structures is below about 10%.

In accord with another aspect of the present disclosure, a method for forming a pseudo-auxetic material includes the acts of providing a body that is at least semi-rigid and forming in the body first elongated void structures and second elongated void structures. Each of the elongated void structures have a major axis and a minor axis, the major axes of the first elongated void structures being at least substantially perpendicular to the major axes of the second elongated void structures, the elongated void structures being arranged in an array of rows and columns, each of the rows and each of the columns alternating between the first and the second elongated void structures, wherein the elongated void structures are sized to exhibit a negative Poisson's ratio behavior under stress.

The above summary is not intended to represent each embodiment or every aspect of the present disclosure. Rather, the summary merely provides an exemplification of some of the novel features presented herein. The above features and advantages, and other features and advantages of the present disclosure, will be readily apparent from the following detailed description of exemplary embodiments and modes for carrying out the present invention when taken in connection with the accompanying drawings and the appended claims.

### BRIEF DESCRIPTION OF THE DRAWINGS

FIGS. 1(a)-1(d) are, respectively, a Strain vs. Poisson Ratio plot of experimental data and computer modeling data for a solid comprising elliptical through holes and representations of the structure corresponding to specific data points from the plot.

FIG. 2 is a representation of a load path in a solid having an engineered void structure comprising elliptical holes providing a 40% porosity.

FIG. 3 is a representation of a load path in a solid having an engineered void structure comprising an arrangement of slots and stop holes according to aspects of the present disclosure.

FIG. 4 is a representation of a load path in a solid having an engineered void structure comprising an arrangement of slots according to aspects of the present disclosure.

FIGS. 5(a)-5(b) depict examples of an engineered void structure comprising an arrangement of through holes according to aspects of the present concepts comprising, respectively, large aspect ratio ellipses and double-T shaped slots.

FIG. 6 shows a representation of a material in accord with aspects of the present concepts including an arrangement of engineered void structures enabling the material to exhibit Negative Poisson Ratio (NPR) behavior.

FIG. 7 shows a representation of a unit cell in the material comprising engineered void structures in accord with FIG. 6 according to aspects of the present concepts.

FIGS. 8(a)-8(c) depict examples of a solid having an engineered void structure comprising an arrangement of through holes according to aspects of the present disclosure, showing a flow of stress between adjacent unit locations responsive to an applied localized thermal stress (shown in FIG. 8(b)).

FIGS. 9-30 depict various aspects of and examples of the concepts disclosed herein.

While aspects of this disclosure are susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

This invention is susceptible of embodiment in many different forms. There are shown in the drawings and will herein be described in detail representative embodiments of the invention with the understanding that the present disclosure is to be considered as an exemplification of the principles of the invention and is not intended to limit the broad aspects of the invention to the embodiments illustrated.

For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” mean “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

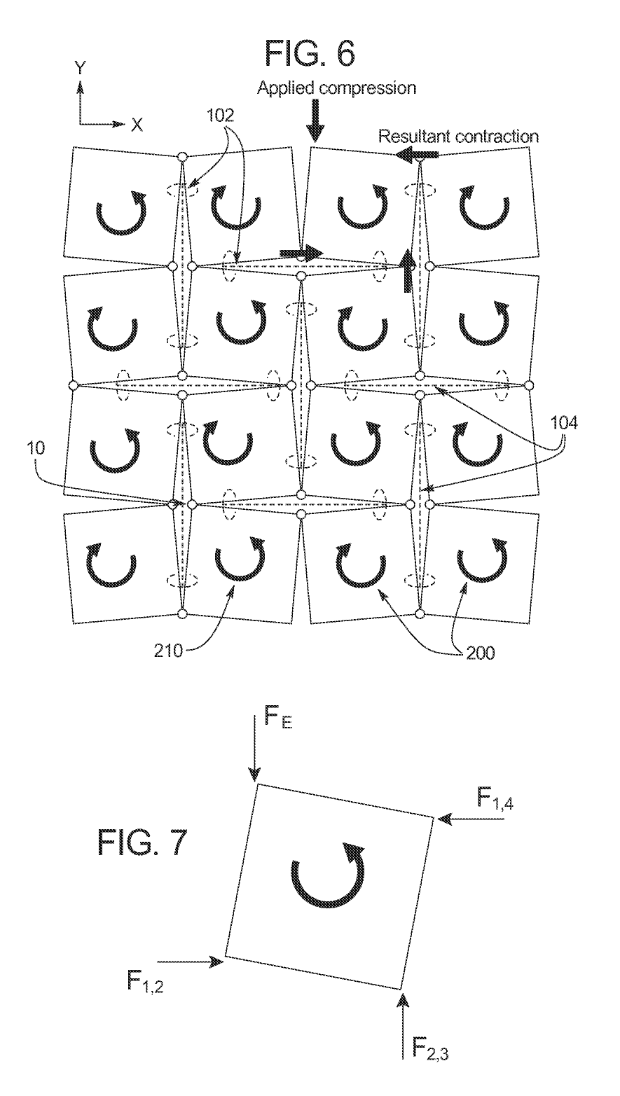

FIG. 6 shows a representation of a material in accord with aspects of the present concepts including an arrangement of engineered void structures 10 (comprising one or more substructures, such as an elongated structure 104 and stress reducing structures 102 at either end of the elongated structure) enabling the material to exhibit Negative Poisson Ratio (NPR) behavior. As is further represented in FIG. 6, when the structure, and more particularly the indicated unit cell 200, is subjected to a compressive force as represented by the arrow pointing in the −Y direction, the compressive force causes a moment 210 around the center of each unit cell 200, causing the cells 200 to rotate. Each cell 200 in turn affects the neighboring unit cells 200, such effect being attributable to the way the adjacent voids or openings 100 (which may comprise one or more substructures 102, 104), are arranged in accord with aspects of the present concepts.

Although the engineered void structures 10 shown in FIG. 6 are shown to be double-T slots, by way of example, other engineered void structures (e.g., large aspect ratio ellipses, other slot shapes, etc.) could be used and would result in a similar NPR behavior.

The forces acting on an individual unit cell 200 are represented, by way of example, in FIG. 7, where F_{E} represents the applied external force, F_{1,2} represents the applied force from the adjacent neighboring cell to the left (as shown, array location F_{x,y}), F_{2,3} represents the applied force from the adjacent neighboring cell below, and F_{1,4} represents the applied force from the adjacent neighboring to the right. Each unit cell 200 rotates in a direction opposite to that of its immediate neighbors, as shown in FIG. 6. This rotation results in a reduction in the X-direction distance between horizontally adjacent cells. In other words, compressing the structure in the Y direction, such as in the manner indicated in FIG. 6 by the arrow pointing in the −Y direction, causes the material comprised of the unit cells 200 to contract in the X direction, thus exhibiting “pseudo-auxetic” or NPR behavior. Conversely, tension in the +Y direction results in expansion in the X direction, again expressing “pseudo-auxetic” or NPR behavior. At the scale of the entire structure, this mimics the behavior of an auxetic material despite the materials forming the unit cells 200 consisting of conventional positive Poisson ration material.

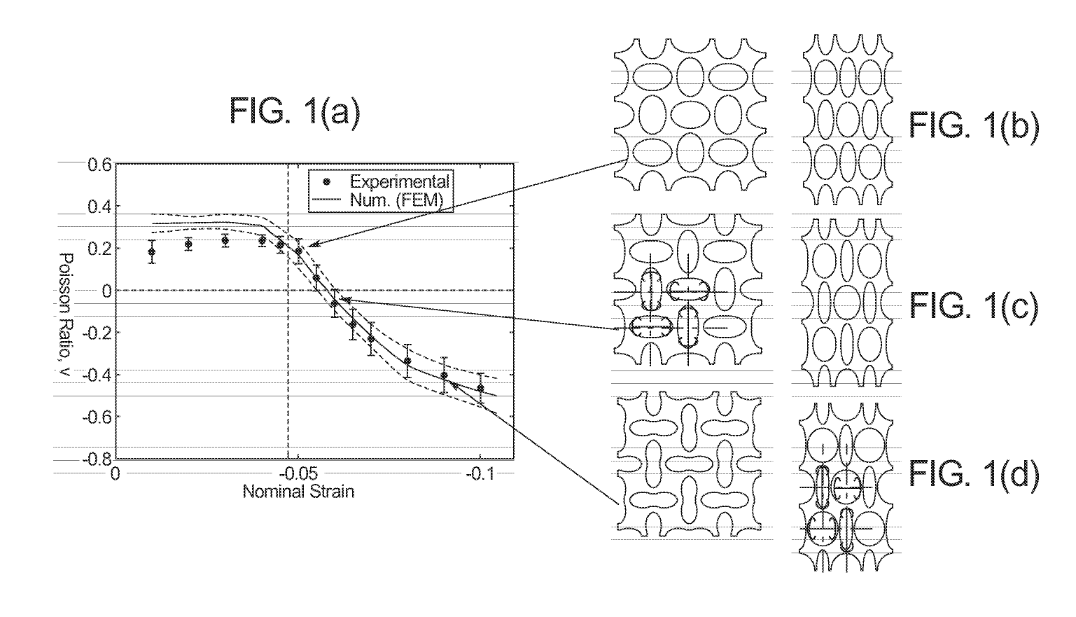

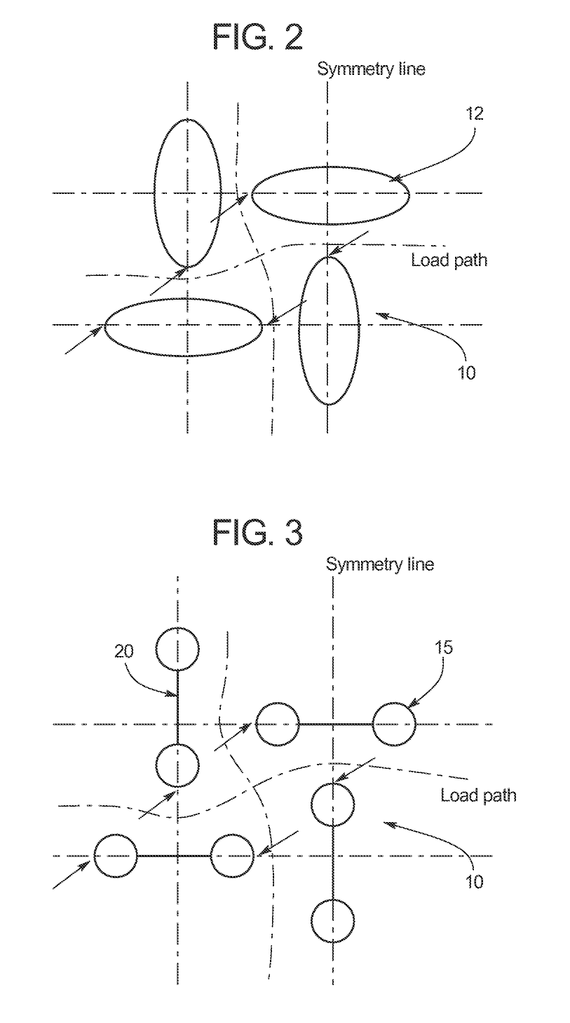

Turning to FIG. 2, the engineered void structure 10 utilized in the studies of FIGS. 1(a)-1(d) is shown, emphasizing a representation of a load path in the solid material. In this example, the engineered void structure comprises elliptical holes 12 defining a 40% porosity. These elliptical holes 12 have a strong curvature and, consequently, a high stress and plasticity with a correspondingly shortened lifespan. The arrows indicate points of maximum curvature of the ellipse and, hence, points of maximum stress.

Although demonstrating proof of the concepts disclosed herein, the sample material having a 40% porosity, as depicted in FIG. 2, would not be suitable for all applications. By way of example, the aforementioned gas turbine combustor liners typically seek to utilize materials (e.g., annular sheets of material) having a porosity of between about 1-3%, with the actual porosity depending on the particular design goals for a given application (e.g., thermal transfer, acoustics, life span, etc.).

FIG. 3 is a representation of another solid having engineered void structures 10, in accord with at least some aspects of the present concepts, comprising an arrangement of slots 20 and stop holes 15 (disposed at each end of a slot 20). This arrangement of slots 20 and stop holes 15 exhibits little curvature, as compared to the ellipses 12 of FIG. 1, and consequently exhibits a low stress and low plasticity with a correspondingly lengthened lifespan. A load path is shown and the arrows indicate points of maximum curvature of the ellipse and, hence, points of maximum stress. The stop holes 15 are used to stop crack propagation and are placed at the end of the straight slot 20 in order to reduce the stress at this location. The slot 20 length is sized in order to generate an intended behavior.

In contrast to the ellipses 12 of FIG. 2, the arrangement of slots 20 and stop holes 15 of FIG. 3 exhibits a porosity of only about 3-4%, which renders this structure suitable for particular applications involving gas turbine combustors. Of course, for such applications, the structure would be embodied within materials suitable for such application including, but not limited to, polycrystalline or single-crystal nickel-base, iron-nickel-base and cobalt-base superalloys or other high-temperature, corrosion-resistant alloys, without limitation. Examples of such alloys include, but are not limited to, Inconel (e.g. IN600, IN617, IN625, IN718, IN X-750, etc.), Waspaloy, Rene alloys (e.g. Rene 41, Rene 80, Rene 95, Rene N5), Haynes alloys (e.g., Hastelloy X), Incoloy, MP98T, TMS alloys, and CMSX (e.g. CMSX-4) single crystal alloys.

Again, it is to be emphasized that the engineered void structures 10 disclosed by way of example herein enable ordinary positive Poisson ratio materials, such as the superalloys noted above, to exhibit “pseudo-auxetic” or NPR behavior. A combustor liner, by way of example, is made from a material comprising a specific void structure for the intended application. In contrast to conventional materials utilizing known patterns of elliptic voids having an aspect ratio of up to 50 in order to get the intended behavior (and resulting in a very high stress at the tip), engineered void structures 10 as disclosed herein, such as slots 30 with stress relief features 35 (as discussed below), are able to provide a smaller porosity and, hence, let less air through.

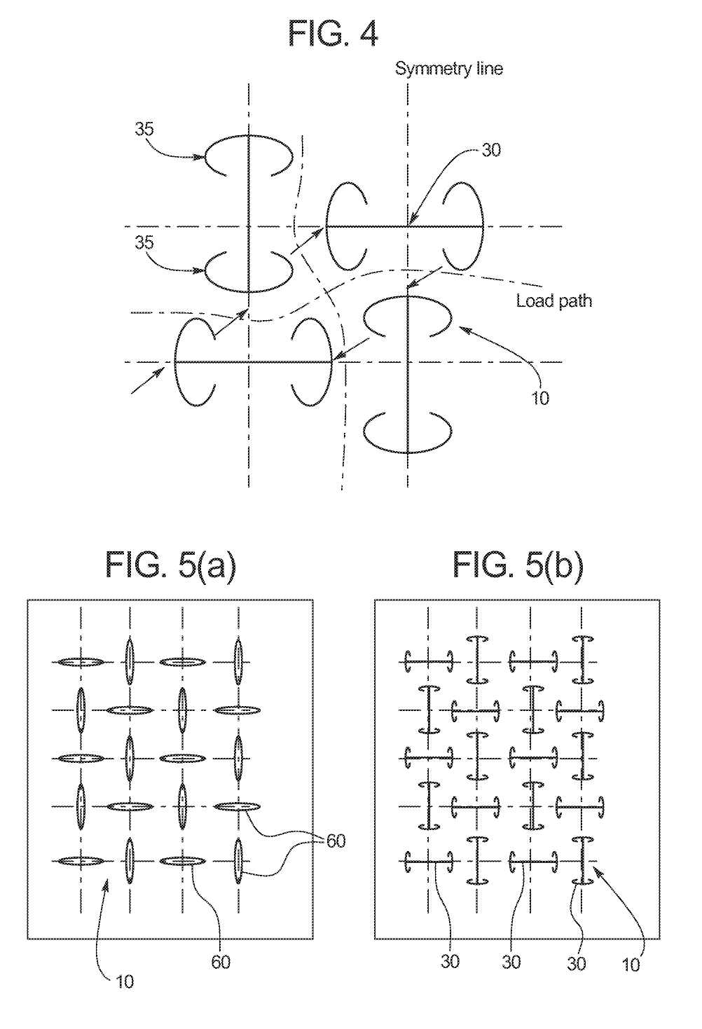

FIG. 4 is a representation of a load path in a solid having an engineered void structure 10 comprising an arrangement of slots 30 according to aspects of the present disclosure. In the example shown, the slots 30 are double-T slots with stress-reducing structures 35 at each end of each slot 30. In the depicted stress-reducing structures 35, the horizontal part of the “T” curves back in the shape of an ellipse with a large curvature at the junction to the vertical section in order to reduce the stress at this location. The slot 30, the vertical part of the “T,” is a straight slot sized in length in order to generate an intended behavior. As with the arrangement of FIG. 3, this arrangement of slots 30 exhibits little curvature, as compared to the ellipses of FIG. 2, and consequently exhibits a low stress and low plasticity with a correspondingly lengthened lifespan. The arrows indicate points of maximum curvature of the ellipse and, hence, points of maximum stress. In contrast to the ellipses 12 of FIG. 2, the slots 30 of FIG. 4 exhibit a porosity of only about 1-2%.

As to the double-T slot structures 30, 35, lowering a degree of curvature of the stress-reducing structures 35 in turn lowers the stress. At the junction of the slot 30 and the stress-reducing structures 35, the curvature is generally flat, which distributes stresses over a larger part of that length producing significant local stress reduction.

In general, the disclosed engineered void structures can be applied to any solid material (e.g., concrete, metal, etc.) and is not limited to, for example, gas turbines or gas turbine combustors. In the exemplary combustor application, however, the disclosed engineered void structures 10 advantageously produce macroscopic pseudo-auxetic behavior (negative Poisson's ratio) with significantly reduced porosity, hence air usage for cooling and damping. Even if this structure were to be made from a “conventional” alloy suitable for such application, it will contract in lateral direction when it is put under axial compression load, without the metal from which it is made having a negative Poisson's ratio. The behavior is, as noted, triggered by the specific engineered void structure itself

FIGS. 5(a)-5(b) depict examples of engineered void structures 10 according to aspects of the present concepts comprising respectively, large aspect ratio ellipses 60 and double-T shaped slots 30, respectively. The engineered void structure 10 pattern in accord with the present concepts comprises horizontal and vertical structures (e.g., slots in the shape of a double T, slots with stop holes, large aspect ratio ellipses, etc.) arranged on horizontal and vertical lines in a way that the lines are equally spaced in both dimensions (also Δx=Δy). Centers of the slots are on the crossing point of the lines and vertical and horizontal slots alternate on the vertical and horizontal lines. Vertical slots are surrounded by horizontal slots along the lines (and vice versa) and the next vertical slots are found on both diagonals. The slot pattern on the outside of a cylindrical component is equivalent to the pattern on the sheet (vertical=axial, horizontal=circumferential). However, in such construction, the slot shape on the inside is different due to the different radius of this surface. Axial slots have a smaller short axis than on the outside but a larger long axis. Circumferential slots have a larger short axis than on the outside but a shorter long axis.

Manipulation of the geometry of the arrangements of engineered void structures 10 in accord with the present concepts can control the manifested Poisson's ratio. By increasing the length(s) of these innovative features, a Poisson's ratio can be tailored, as desired. For example, the major axis of the ellipses 60 in FIG. 5(a) can be increased or decreased in effect to control the Poisson's ratio. The minor axis of the ellipses itself provides variability in the effective Poisson's ratio, but is only of a second order influence on the achievable value on the negative Poisson ratio. Likewise, for other arrangements of engineered void structures 10 in accord with the present concepts, such as the double-T slot, the elongated slot structure (e.g., 104; FIG. 6) is of a first order influence on the negative Poisson ratio and the stress-reducing features or shorter transverse structures are of a second order influence (at least individually), with the enabled rotation of the unit cells 200 enabling (see, e.g., FIG. 6) generating the pseudo-auxetic behavior.

In at least some aspects of the present concepts, the aforementioned test specimen noted above with respect to FIGS. 1(a)-1(d) can be subjected to a load to determine the change in the Poisson ratio as the test specimen is deformed under load. At a certain level of deformation the “instantaneous” Poisson ratio can be determined and plotted against some parameter representing the level of deformation. A designer of a system or component, after deciding what Poisson ratio would be suitable for that particular application, can then determine (e.g., using a look-up table, etc.) the corresponding level of deformation corresponding to the target Poisson ratio and the geometry of the holes at that condition is then determined. This hole geometry can then be machined (manufactured) on an unstressed part to achieve a component with the desired Poisson ratio.

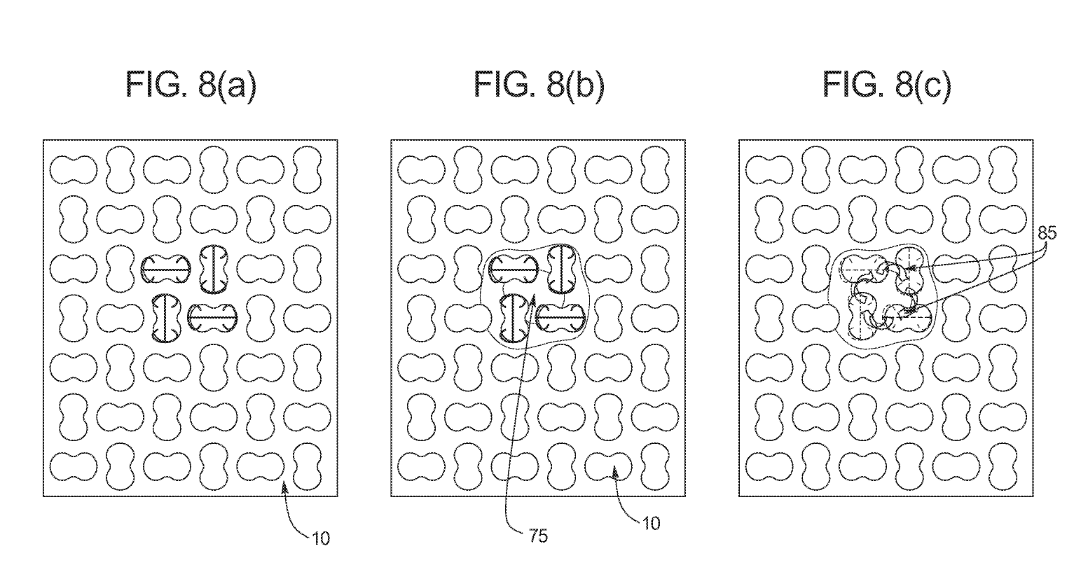

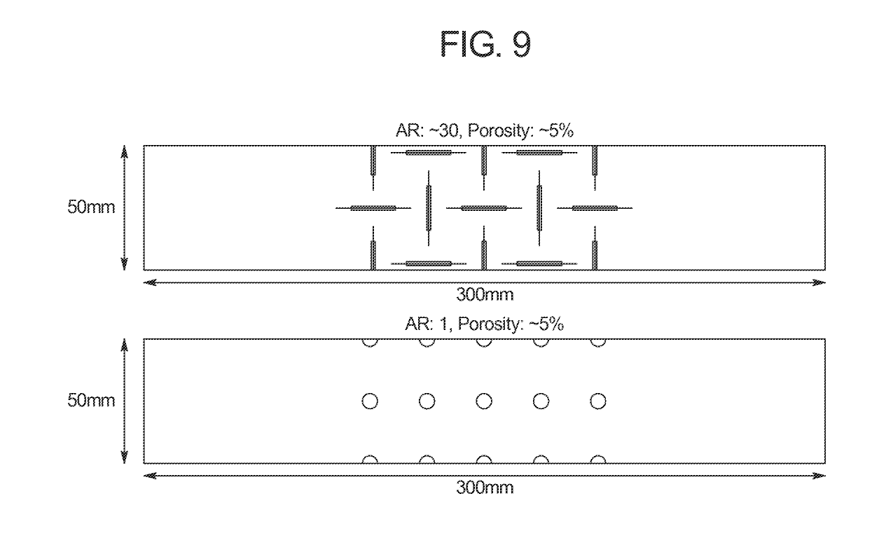

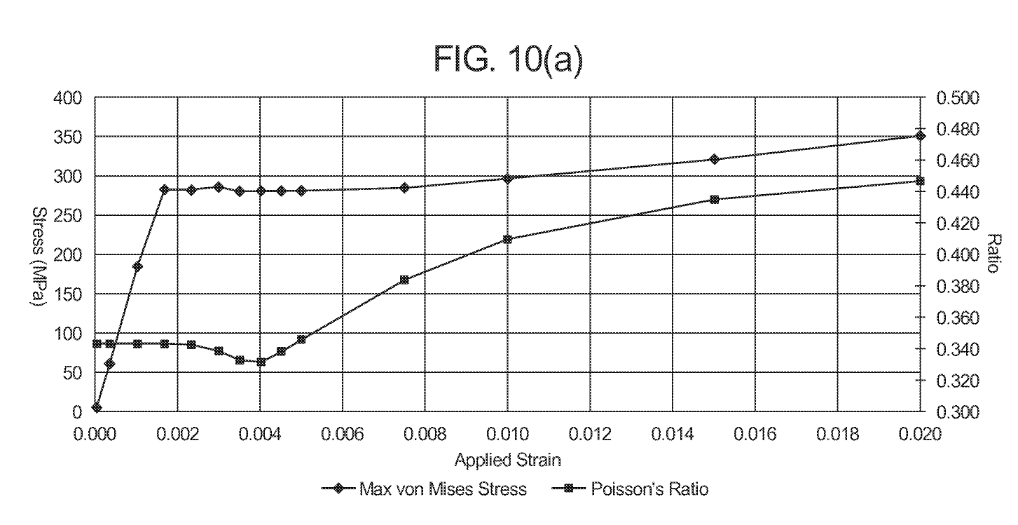

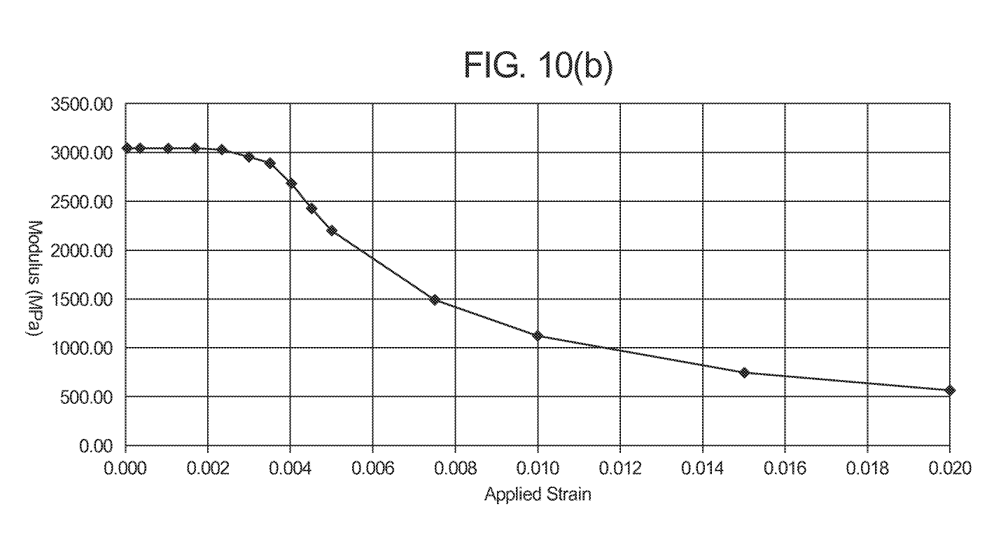

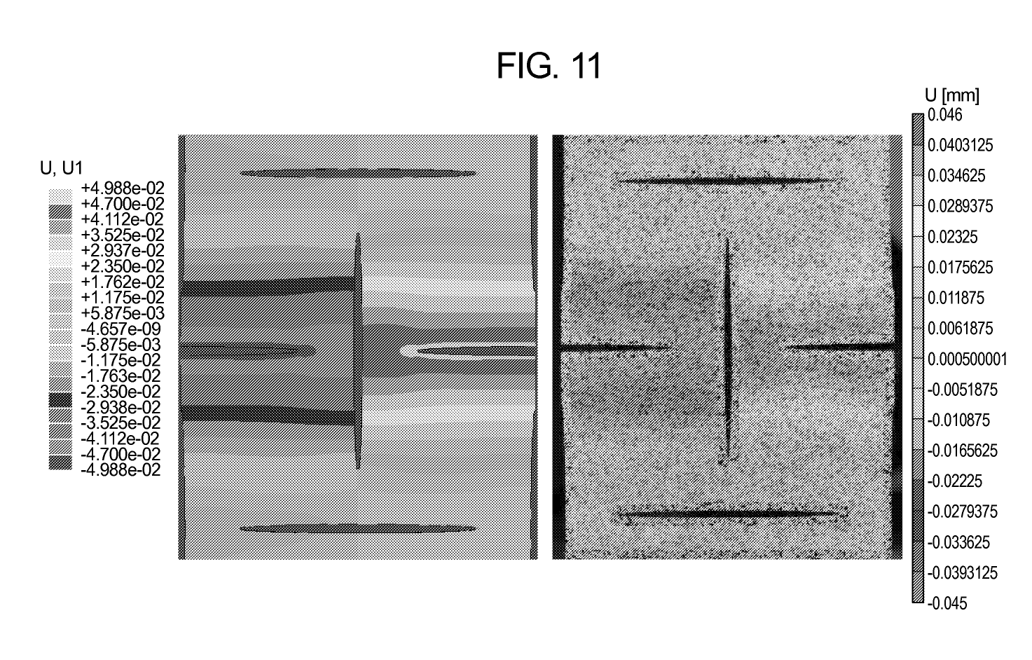

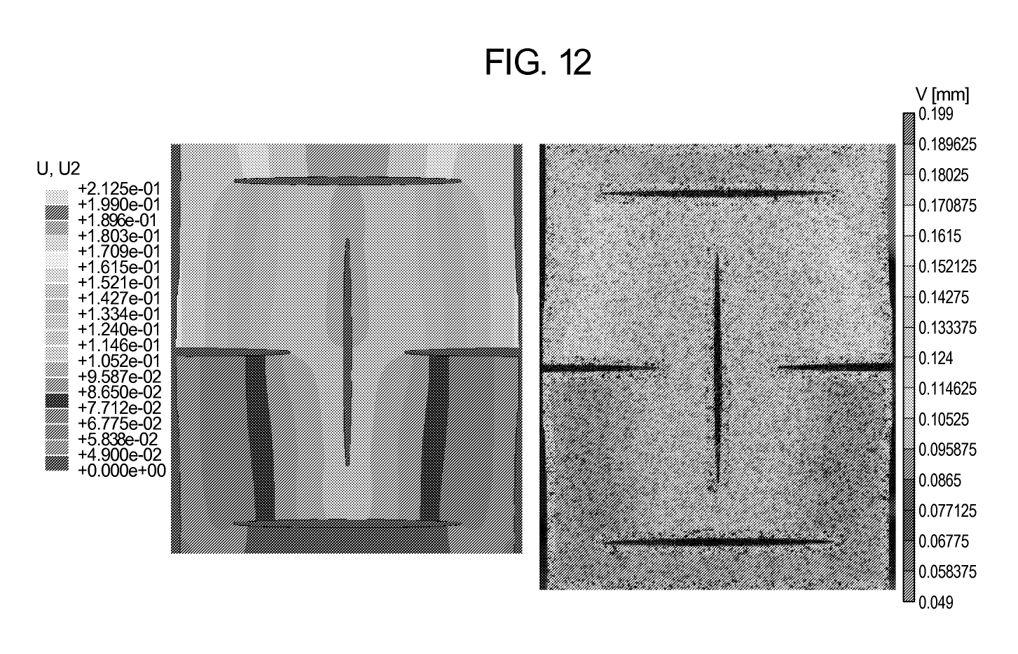

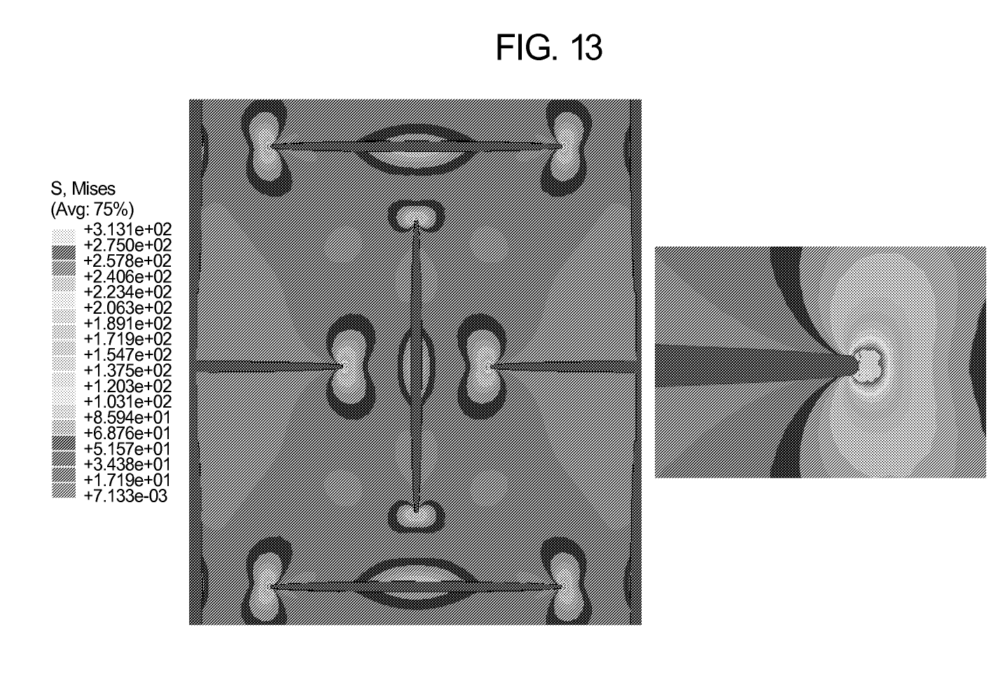

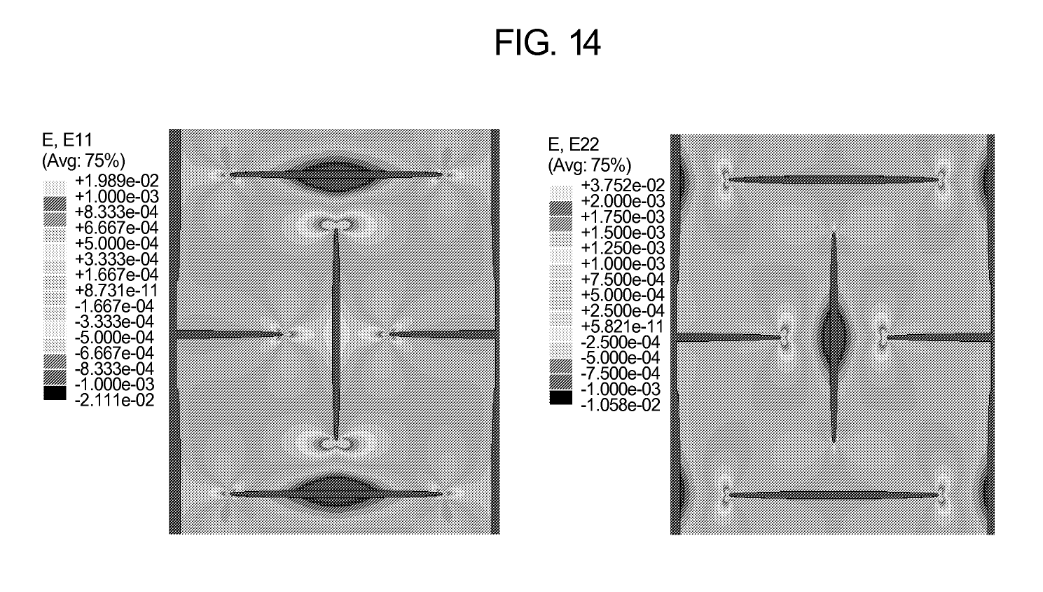

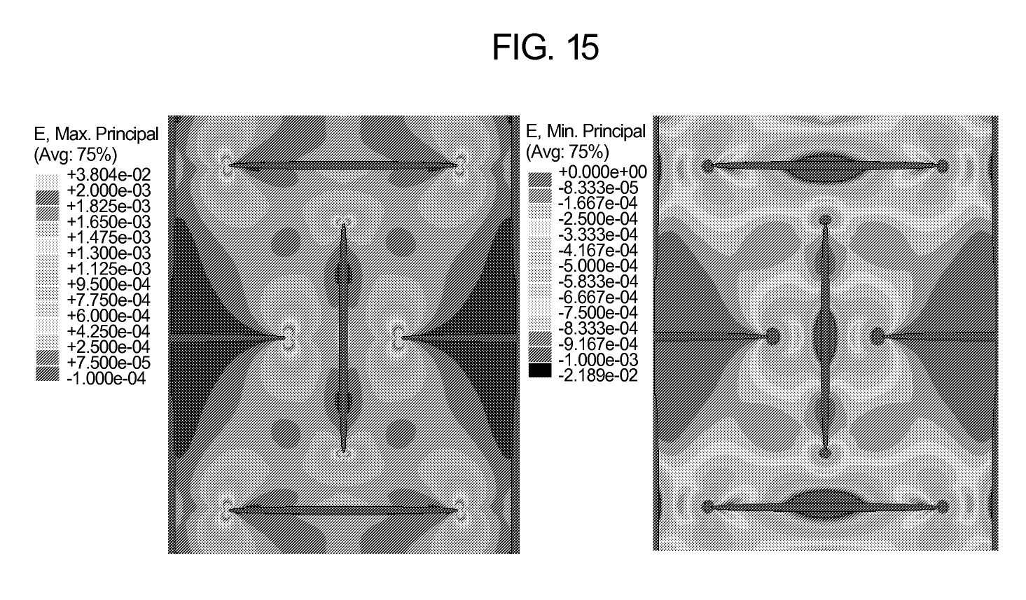

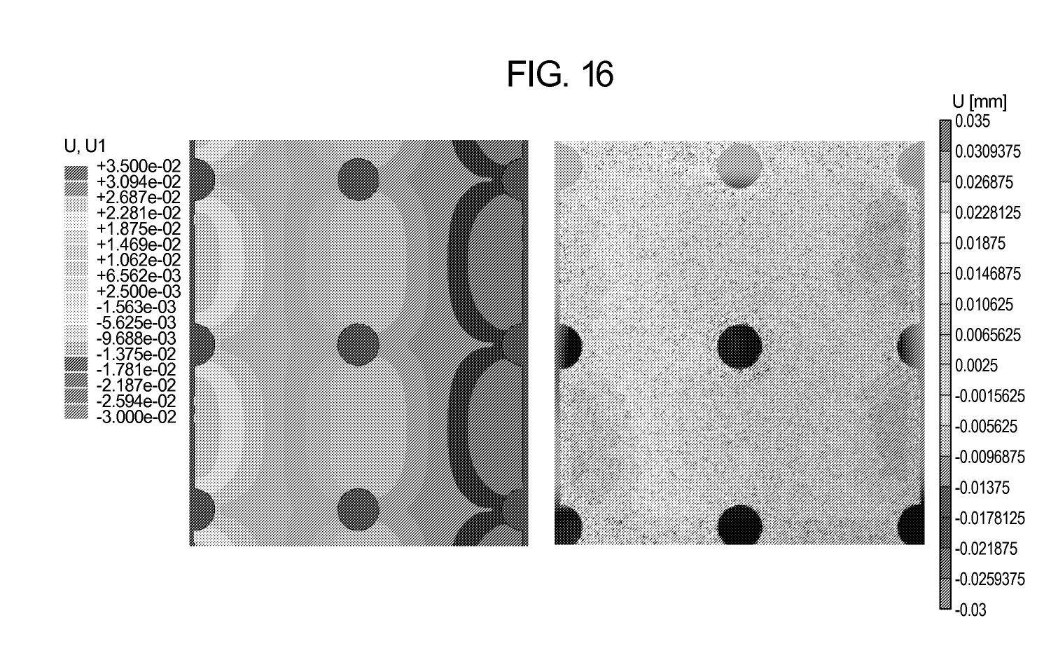

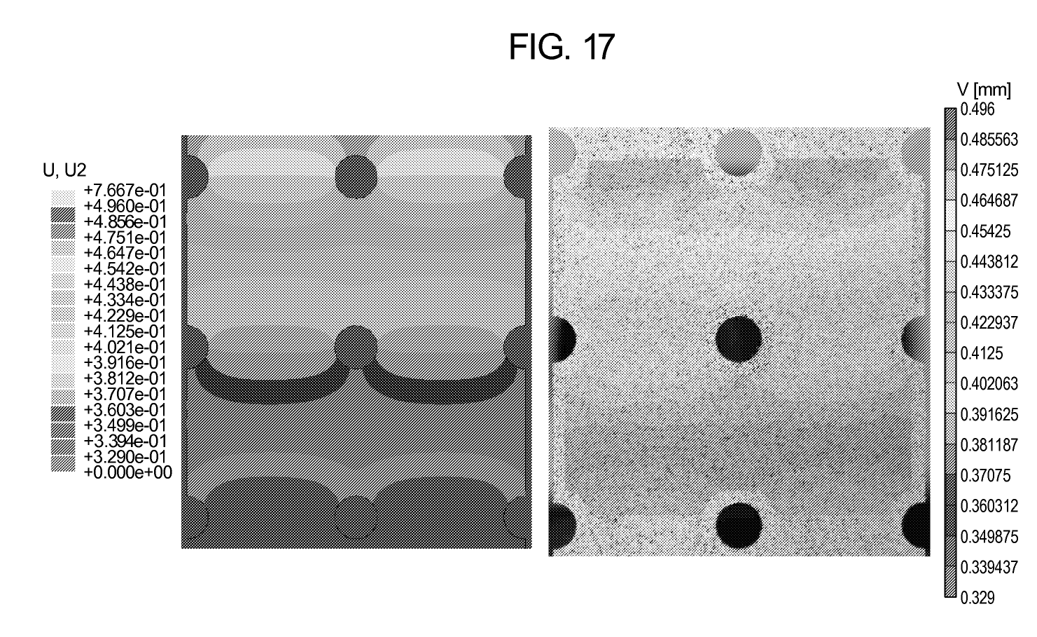

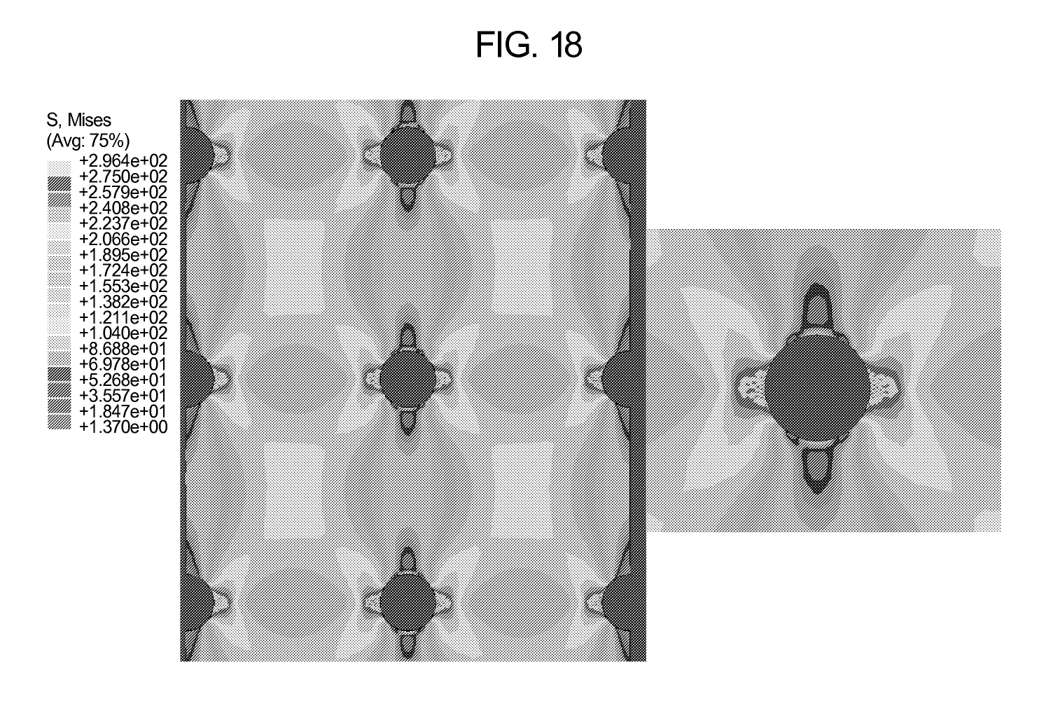

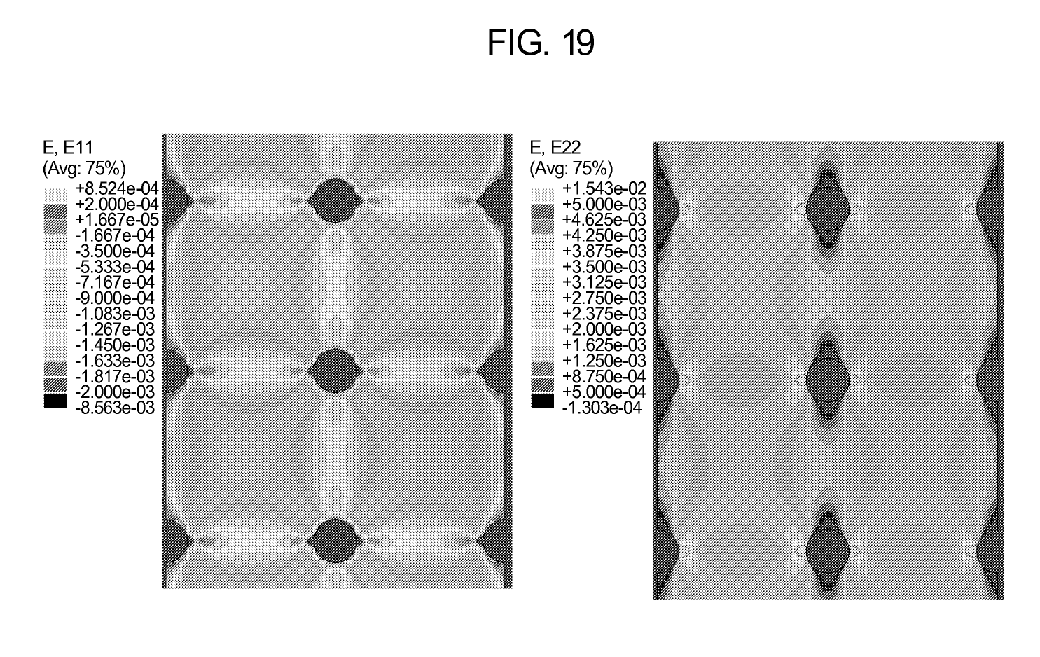

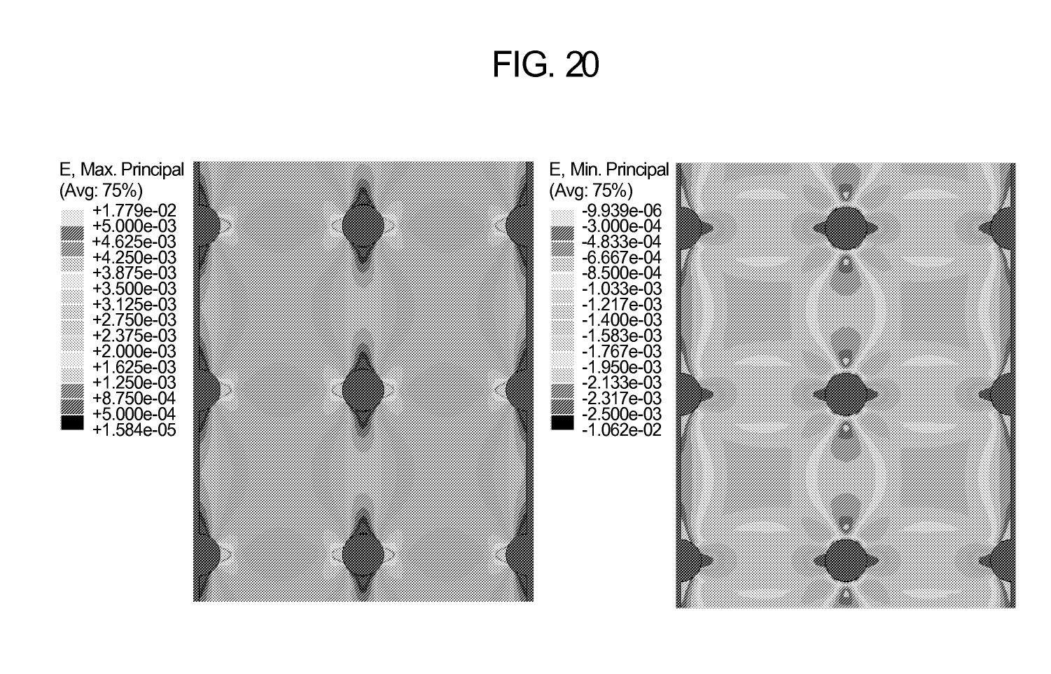

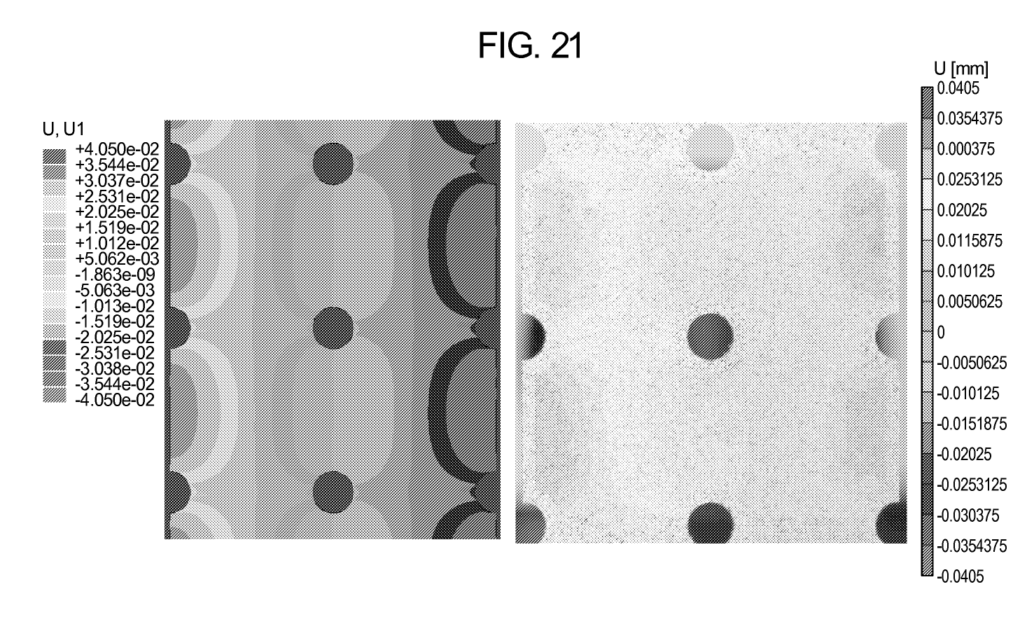

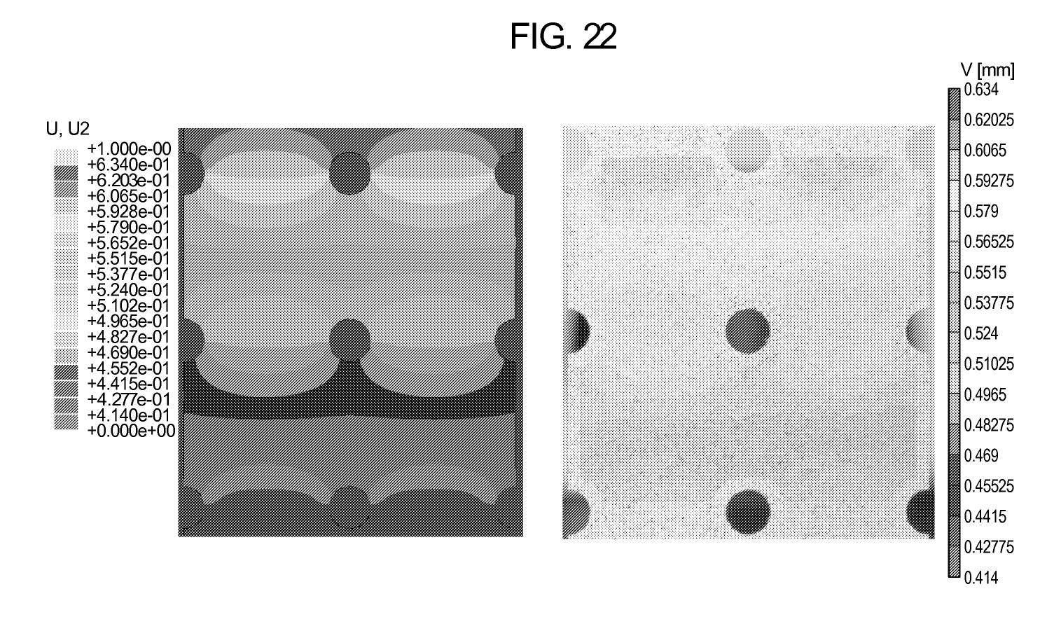

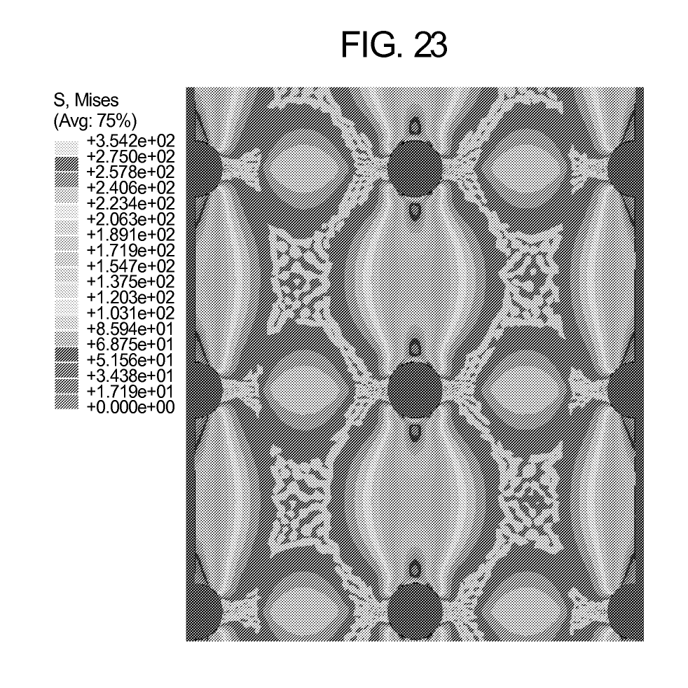

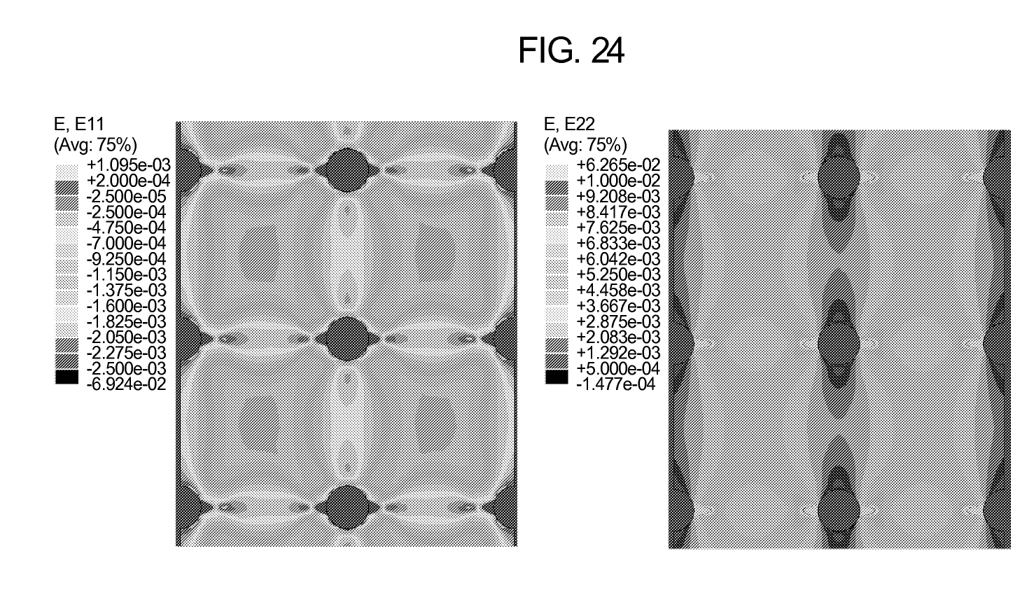

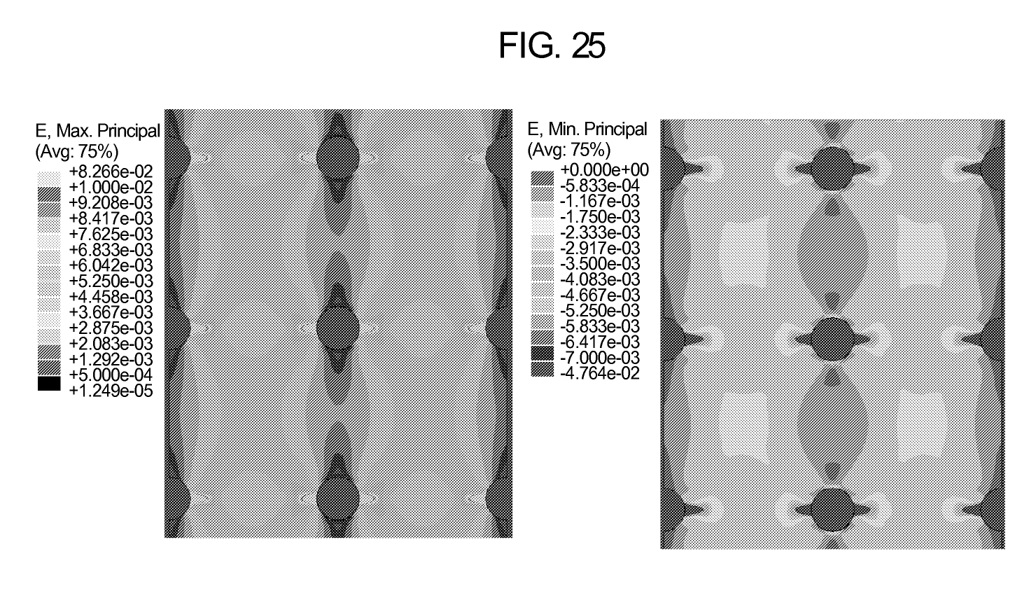

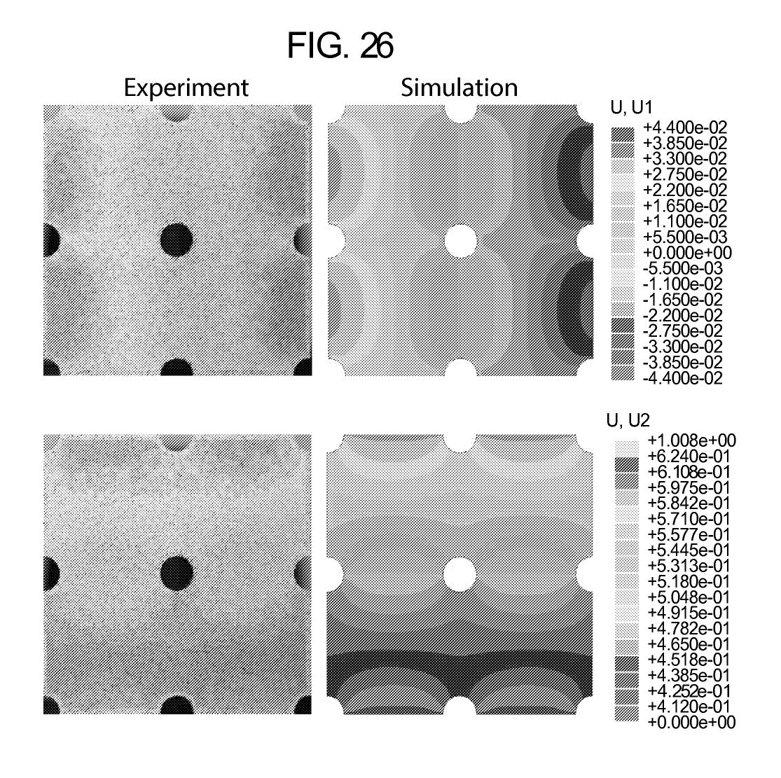

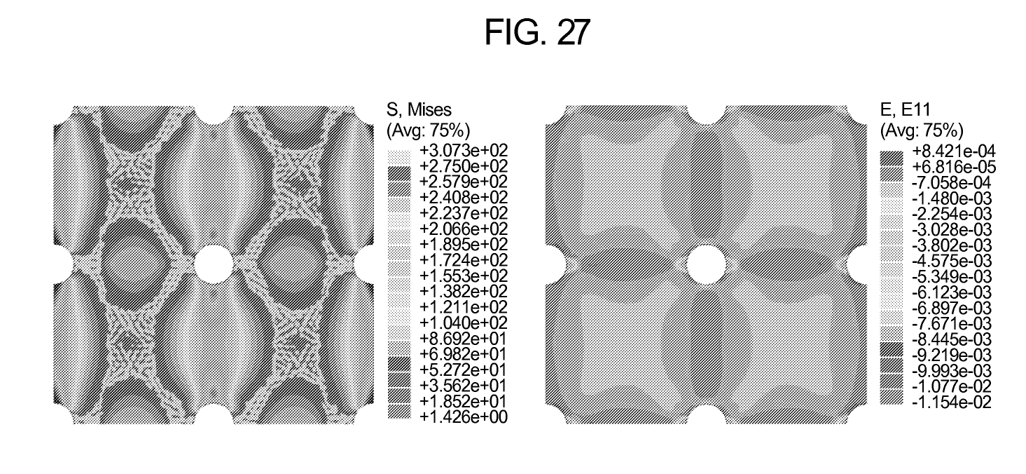

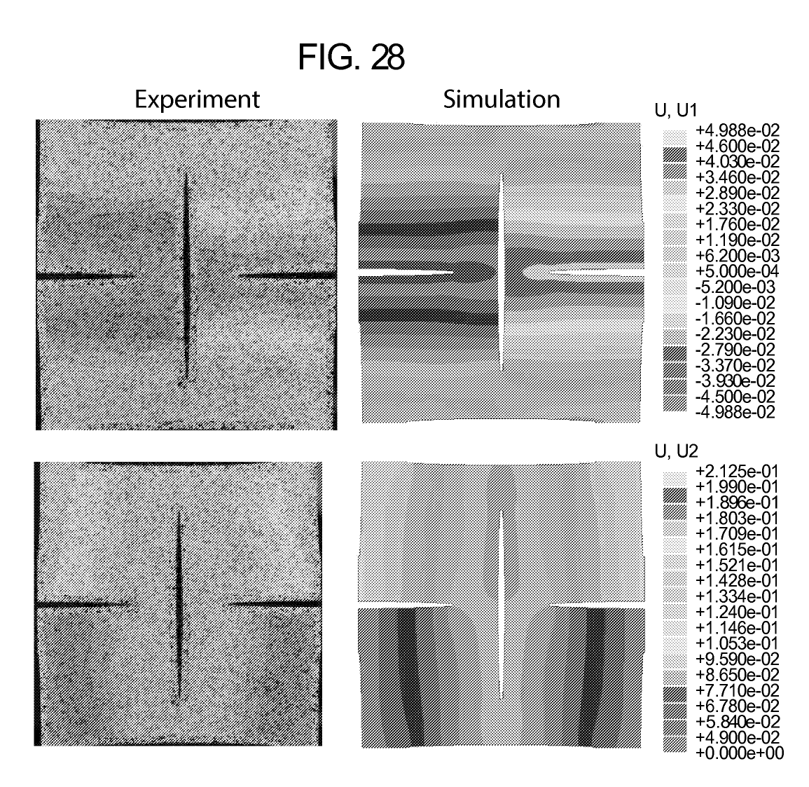

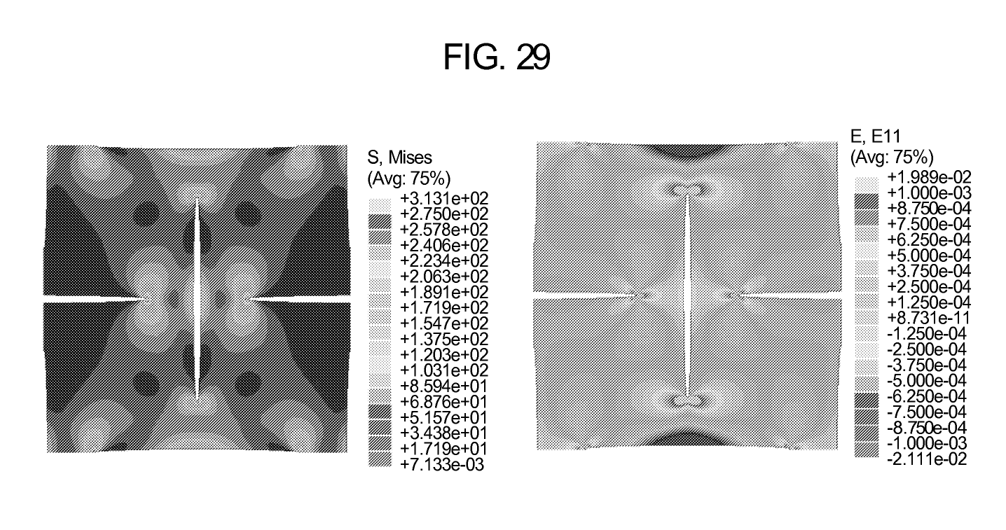

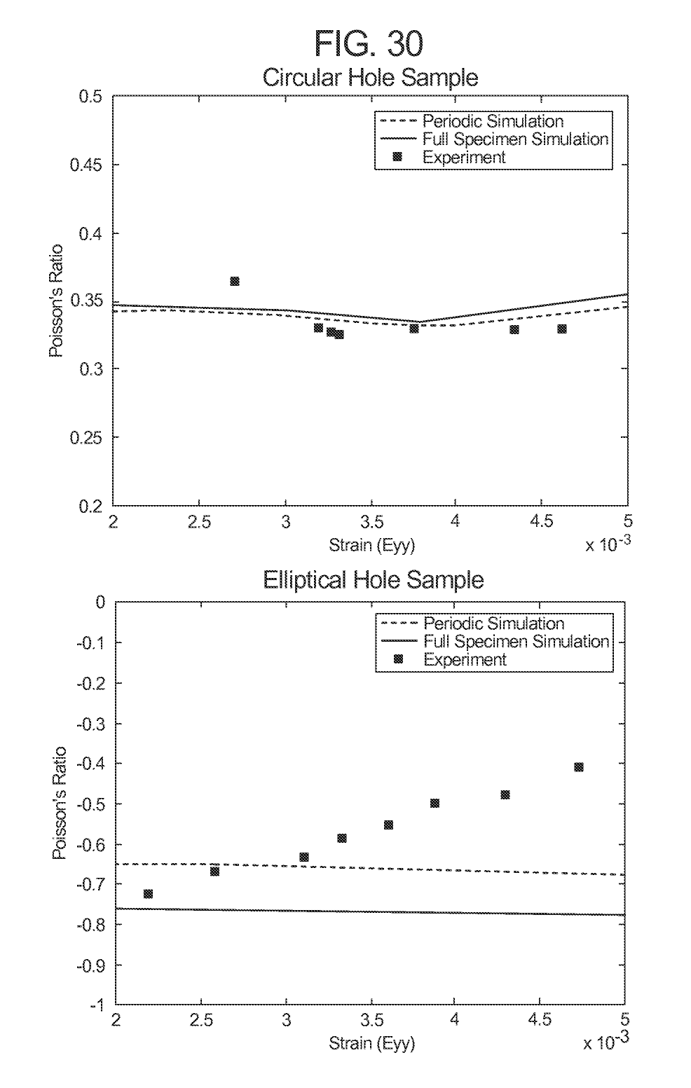

FIGS. 8(a)-8(c) depict examples of a solid having an engineered void structure 10 comprising an arrangement of through holes according to aspects of the present disclosure, showing a substantially steady state condition (FIG. 8(a)), an applied localized thermal stress 75 (FIG. 8(b)), and a flow of stress (arrows 85) between adjacent unit locations responsive to the applied localized thermal stress (FIG. 8(c)). In accord with the present concepts, a material comprising an engineered void structure 10 as disclosed herein, responsive to a hot spot compressive stress in one direction, causes the positive Poisson ratio material to exhibit NPR properties and contract in the other direction, reducing the thermal stress in this direction. The mechanism also works vice versa, so the thermal stress induced by a hot spot gets strongly reduced in all directions. This effect is stronger than just the impact of the reduced stiffness. Stress at hot spot is reduced by 50%, leading to an increase in stress fatigue life by several orders of magnitude.

As another benefit to the engineered void structures 10 disclosed herein, slots with stop holes (e.g., FIG. 3) or double-T slots (e.g., FIG. 4) removes less material from the sheet in which they are formed, hence expediting manufacture. Further, as previously noted, slots with stop holes (e.g., FIG. 3) or double-T slots (e.g., FIG. 4) have significantly less void fraction (lower porosity), resulting in a drastic reduction in air usage (e.g., as used in gas turbine applications).

The void structures 10 disclosed herein can advantageously be formed in different sizes and/or geometries in relation to the application. By way of example, a cooling or damping hole in a gas turbine hot section component is typically in the range of about 0.5 mm to 3 mm in diameter. In such an application, the void structures 10 in accord with the present aspects of the invention would be configured with approximately the same cross sectional area to facilitate the same degree of air flow. Where slots with stop holes (e.g., FIG. 3) are provided, the stop holes could just take the place of the conventional hole configuration. Hence the hole might cover the same diameter range of about 0.5 mm to 3 mm and be spaced apart between 2 mm to 20 mm. The slot would bridge the distance between two adjacent holes. Similarly, as to the sizing of the slots and transverse stress reducers in the double-T slot (see, e.g., FIG. 4), the longitudinal length of the double-T slot has the same dimension as in the previous shape, so between 2 mm and 20 mm. The transversal extension for stress reduction might be between 10% and 50% of the longitudinal length. Regarding the large aspect ratio ellipse, the long axis dimension (tip to tip) is expected to be between 2 mm and 20 mm and have an aspect ratio between 5 and 50.

The size of the voids is influenced by the thickness of the component and the manufacturing method. The exemplary, non-limiting dimensions above are mainly related to laser manufacturing and an operation in a mildly dusty environment such as a gas turbine engine. Under clean air conditions, for example, the feature size could be reduced and then the void could be manufacture by electron beam cutting at approximately 1/10 of the size given above or smaller.

While many embodiments and modes for carrying out the present invention have been described in detail above, those familiar with the art to which this invention relates will recognize various alternative designs and embodiments for practicing the invention within the scope of the appended claims. For example, each of the engineered void structures 10 disclosed herein may comprise a single structure (e.g., large aspect ratio ellipses) or plural structures (e.g., a slot with stress reducers at each end). These structures may be formed in an existing material and/or formed during the formation process of the material using any processing method such as, but not limited to, laser cutting, electron beam cutting, water jet cutting, photolithography (optical lithography, UV lithography, etc.), or microfabrication.

It is to be understood that although each of the embodiments described herein utilized the same structures uniformly, the present concepts include utilizing different structures disclosed herein in combination. For example, an arrangement of void structures 10 in a single structure, in accord with the present concepts, may include a combination of any of large aspect ratio ellipses and/or a slot with stress reducers and/or a slot with stop holes at both ends and/or double-T shaped slots.

Moreover, the shapes of the voids disclosed herein are not limiting. Different shapes can be used in accord with the present concepts, so long as the NPR behavior shown in FIG. 6 is achieved and the unit cells rotate in the respective directions described. The shapes of the voids can be selectively changed based on the requirements of the application.

Further, appended hereto are slides corresponding to application of the present concepts to a structure formed of metal, as contrasted to a conventional structure having a regular array of circular through holes, demonstrating that the present concepts work in metal as well as the tested rubber.

What is claimed is:

1. A low porosity sheet material comprising:
an arrangement of elongated void structures, each of the elongated void structures comprising one or more substructures, a first plurality of first elongated void structures and a second plurality of second elongated void structures, each of the first and second elongated void structures having a major axis and a minor axis, the major axes of the first elongated void structures being perpendicular to the major axes of the second elongated void structures, the first and second pluralities of elongated void structures being arranged in an array of rows and columns, each of the rows and each of the columns alternating between the first and the second elongated void structures,
wherein a porosity of the elongated void structures is below about 10%.

2. The low porosity sheet material according to claim 1, wherein the first and second elongated void structures comprise large aspect ratio ellipses.

3. The low porosity sheet material according to claim 1, wherein the wherein a porosity of the elongated void structures is below about 4%.

4. The low porosity sheet material according to claim 3, wherein the first and second elongated void structures comprise double-T slots.

5. The low porosity sheet material according to claim 3, wherein the first and second elongated void structures comprise slots with stop holes at both ends of the slots.

6. The low porosity sheet material according to any one of claims 1-5, wherein the sheet material comprises at least one of a polycrystalline or single-crystal alloy.

7. The low porosity sheet material according to claim 6, wherein the sheet material comprises a nickel-base, iron-nickel-base or cobalt-base superalloy.

8. The low porosity sheet material according to any one of claims 1-5, wherein the arrangement of elongated void structures define unit cells that, responsive to a uniaxial stress, cause the sheet material to exhibit negative Poisson ratio characteristics.

9. The low porosity sheet material according to claim 8, wherein in the arrangement, the rows are equally spaced from each other and the columns are equally spaced from each other.

10. The low porosity sheet material according to claim 9, wherein each of the elongated void structures includes a center at intersections of the major and minor axes, the center of each of the elongated void structures being located at a respective intersection point of one of the rows and one of the columns of the array.

11. The low porosity sheet material according to claim 9, wherein a spacing of the elongated void structures in the material does not change when the material placed under stress.

12. The low porosity sheet material according to claim 9, wherein a shape of the elongated void structures in the material does not change when the material placed under stress.

13. A method for forming a pseudo-auxetic material, the method comprising:
providing a body that is at least semi-rigid; and
forming in the body first elongated void structures and second elongated void structures, wherein each of the elongated void structures have a major axis and a minor axis, the major axes of the first elongated void structures being at least substantially perpendicular to the major axes of the second elongated void structures, the elongated void structures being arranged in an array of rows and columns, each of the rows and each of the columns alternating between the first and the second elongated void structures, wherein the elongated void structures are sized to exhibit a negative Poisson's ratio behavior under stress.

14. The method for forming a pseudo-auxetic material according to claim 13, wherein the first and second elongated void structures comprise large aspect ratio ellipses.

15. The method for forming a pseudo-auxetic material according to claim 13, wherein a porosity of the elongated void structures is below about 4%.

16. The method for forming a pseudo-auxetic material according to claim 15, wherein the first and second elongated void structures comprise double-T slots.

17. The method for forming a pseudo-auxetic material according to claim 15, wherein the first and second elongated void structures comprise slots with stop holes at both ends of the slots.

18. The method for forming a pseudo-auxetic material according to any of claims 13-17, wherein in the arrangement, the rows are equally spaced from each other and the columns are equally spaced from each other.

19. The method for forming a pseudo-auxetic material according to any of claims 13-17, wherein each of the elongated void structures includes a center at intersections of the major and minor axes, the center of each of the elongated void structures being located at a respective intersection point of one of the rows and one of the columns of the array.

20. The method for forming a pseudo-auxetic material according to claim 19, wherein each of the elongated void structures includes a center at intersections of the major and minor axes, the center of each of the elongated void structures being located at a respective intersection point of one of the rows and one of the columns of the array.
